(19) United States
(12) Patent Application Publication
(10) Pub. No.: US 2013/0258320 A1
(43) Pub. Date: Oct. 3, 2013

(54) METHOD AND APPARATUS FOR INSPECTING SURFACE OF A MAGNETIC DISK

(71) Applicant: HITACHI HIGH-TECHNOLOGIES CORPORATION, Tokyo (JP)

(72) Inventors: Toshiharu FUNAKI, Kamisato-machi (JP); Yu YANAKA, Kamisato-machi (JP); Farizbin ABDULRASHID, Kamisato-machi (JP)

(73) Assignee: HITACHI HIGH-TECHNOLOGIES CORPORATION, Tokyo (JP)

(21) Appl. No.: 13/757,056

(22) Filed: Feb. 1, 2013

(30) Foreign Application Priority Data
Mar. 30, 2012 (JP) 2012-079605

(51) Int. Cl. G01N 21/95

(52) U.S. Cl. CPC G01N 21/95
USPC 356/73

(57) ABSTRACT

In a method and an apparatus for inspecting a surface of a disk, a disk that is a sample is rotated, and a light beam is applied to the sample while moving the sample in the direction perpendicular to the center axis of rotation. Light reflected and scattered from the sample in a first direction is detected to obtain a first detection signal while applying the light beam. Light reflected and scattered from the sample in a second direction is detected to obtain a second detection signal while applying the light beam. The first detection signal and the second detection signal are processed to detect a defect on the sample. A preset threshold is compared with the output level of the first detection signal or the output level of the second detection signal to determine whether the material of the disk that is the sample is a predetermined material.

### BACKGROUND

The present invention relates to a method for optically inspecting defects on a sample surface and an apparatus therefor, and more particularly to a disk surface inspection method for inspecting defects on a sample surface in the case where a sample material is a glass material and an apparatus therefor.

Aluminum (Al) substrates or glass substrates are used for magnetic disk substrates. Glass ceramic (SX) or amorphous glass (MEL) is used for a glass substrate depending on applications. A plurality of types of glass including different components are used for glass ceramic or amorphous glass.

Since the process steps of glass substrates are varied depending on materials, when different types of glass substrates are included in manufacturing processes, it is likely to produce defective products.

In order to prevent different types of glass substrates from being included in manufacturing processes, conventionally, an operator visually examines glass substrates. However, since it is likely to cause uninspected substrates under visual examination, it is desired to automate inspection for stable, uniform inspection.

On the other hand, defects on the surface of a glass substrate are optically inspected using an optical inspection apparatus. In an apparatus for inspecting the surface of a glass substrate, there are needs to sort detected defects for the purpose of contributing to increasing the sophistication of process management and improving process steps. The detection optical system of an apparatus for inspecting the surface of a magnetic disk substrate is generally equipped with a plurality of detectors. In addition to sorting micro defects based on detection signals from the detectors, defects are sorted based on the characteristics of the distribution shape of the defects in the magnetic disk surface.

For a conventional apparatus for inspecting defects on the surface of a magnetic disk, there is Japanese Patent Application Laid-Open Publication No. 2000-180376, for example, in which a laser beam is applied to a magnetic disk that is an inspection subject sample, reflected light and scattered light from the magnetic disk surface are received at a plurality of detectors, and micro defects are sorted according to the light receiving conditions of photodetectors. Moreover, the continuity of the detected micro defects on a plane surface is determined to sort the size of the length of defects, linear defects, and massive defects.

Furthermore, Japanese Patent Application Laid-Open Publication No. 2006-352173 describes that the surface of a semiconductor wafer is inspected to sort defects depending on the states of the distributions of obtained defects.

In addition, Japanese Patent Application Laid-Open Publication No. 2011-122998 describes that histogram data of the number of defects is created for individual radii of a substrate to detect circumferential flows and island defects.

### SUMMARY

In conventional optical inspection apparatuses for optically inspect defects on the surface of a glass substrate, a light beam is applied to a substrate, reflected light or scattered light from the substrate is detected at a plurality of detectors disposed in different directions of angles of elevation, detected signal levels are compared with a preset threshold, and it is determined that a defect is detected when a signal greater than a threshold is detected.

However, since the surface reflectance of a substrate is different when glass substrate types or components included in a substrate are varied, in the case of including a glass substrate, which is not an original inspection subject, the detected signal level of reflected light or scattered light from a normal portion is higher than the signal level of an original inspection subject substrate. Thus, when a preset threshold for an original inspection subject substrate is used to detect defects, signals that are not originally to be detected as defects are also wrongly detected as defects, or the detected signal level is lower than the signal level of the original inspection subject substrate. As a result, when the preset threshold for the original inspection subject substrate is used to detect defects, it is unlikely to correctly detect defects because it is difficult to detect defects that are originally to be detected as defects, for example.

In the descriptions in Japanese Patent Application Laid-Open Publication No. 2000-180376, Japanese Patent Application Laid-Open Publication No. 2006-352173, and Japanese Patent Application Laid-Open Publication No. 2011-122998, a premise is that samples, which are inspection subjects, are a type of samples to be originally inspected, and the case is not considered in which samples, which are inspection subjects, include a sample of different optical properties and the reflectance of the sample is not an original inspection subject. Therefore, such an event is not considered in which even non-defective samples have different sample surface reflectances depending on materials and the detection levels of reflected light and scattered light from normal portions are varied.

Thus, the present invention is to provide a method and apparatus for inspecting the surface of a disk that address the problems of the conventional techniques, allow examination whether an inspection subject substrate is a type of a substrate, which is an original inspection subject, and the substrate that is determined as a type of an original inspection subject substrate is correctly inspected for detecting defects, even though a glass substrate, which is not an original inspection subject, is included.

In order to address the above-described problems, an aspect of the present invention is a disk surface inspection apparatus including: a stage unit on which a disk that is a sample is placed, the stage unit being rotatable and movable in a direction perpendicular to a center axis of rotation; an illuminating unit configured to apply a light beam to the sample placed on the stage unit; a first detecting unit configured to detect light reflected and scattered from the sample in a first direction by the illumination of light beam from the illuminating unit; a second detecting unit configured to detect light reflected and scattered from the sample in a second direction by the illumination of light beam from the illuminating unit; and a processing unit configured to process a first detection signal obtained by detecting the light reflected and scattered from the sample in the first direction at the first detecting unit and a second detection signal obtained by detecting the light reflected and scattered from the sample in the second direction at the second detecting unit and detect a defect on the sample.

The processing unit compares a preset threshold with an output level of the first detection signal detecting the light reflected and scattered from the sample in the first direction at the first detecting unit or an output level of the second detection signal detecting light reflected and scattered from the sample in the second direction at the second detecting unit, and determines whether a material of the disk that is the sample is a predetermined material.

Moreover, in order to address the above-described problems, another aspect of the present invention is a disk surface inspection method, including the steps of: rotating a disk that is a sample and applying a light beam to the sample while moving the sample in a direction perpendicular to a center axis of rotation; detecting light reflected and scattered from the sample, on which the light beam is applied, in a first direction to obtain a first detection signal; detecting light reflected and scattered from the sample, on which the light beam is applied, in a second direction to obtain a second detection signal; processing the first detection signal and the second detection signal to detect a defect on the sample; and comparing a preset threshold with an output level of the first detection signal or an output level of the second detection signal to determine whether a material of the disk that is the sample is a predetermined material.

In the present invention, a method and an apparatus are improved to identify the material of a substrate according to optical inspection even though different types of glass materials are included, so that disk types can be identified and determined by automatic inspection.

These features and advantages of the present invention will be apparent from the following more particular description of preferred embodiments of the invention, as illustrated in the accompanying drawings.

### BRIEF DESCRIPTION OF THE DRAWINGS

FIG. 1A is a block diagram of the schematic configuration of a disk surface inspection apparatus according to a first embodiment;

FIG. 1B is a block diagram of the configuration of a pre-processing unit of the disk surface inspection apparatus according to the first embodiment;

FIG. 1C is a plan view of a sample illustrating an r direction and a θ direction on a sample surface according to the first embodiment;

FIG. 2A is a graph illustrating differences in the detection level of reflected light caused by differences in the materials of samples, which is a graph illustrating signals outputted from a detector in the case where no defects are on the sample surface;

FIG. 2B is a graph illustrating differences in the detection level of reflected light caused by differences in the materials of samples, which is a graph illustrating signals outputted from a detector in the case where defects are on the sample surface;

FIG. 2C is a graph illustrating differences in the detection level of reflected light caused by differences in the materials of samples, which is a graph illustrating results that signals outputted from a detector are smoothed in the case where defects are on the sample surface;

FIG. 3 is a flowchart of a process flow of determining the rank of a substrate according to the first embodiment;

FIG. 4A is a front view of a display screen showing results of determining the rank of a substrate according to the first embodiment, illustrating a display screen in the case where the material of a substrate is determined as a predetermined material;

FIG. 4B is a front view of a display screen showing results of determining the rank of a substrate according to the first embodiment, illustrating a display screen in the case where the material of a substrate is determined that the material is not a predetermined material;

FIG. 5 is a block diagram of the internal configuration of a processing device of a disk surface inspection apparatus according to a second embodiment;

FIG. 6 is a flowchart of a process flow of determining the rank of a substrate according to the second embodiment;

FIG. 7 is a graph illustrating differences in the detection level of reflected light caused by differences in the materials of samples, which is a graph illustrating results that signals outputted from a detector are smoothed in the case where defects are on the sample surface; and

FIG. 8 is a front view of a display screen showing results of determining the rank of a substrate according to the second embodiment, illustrating a display screen in the case where the material of a substrate is determined as a predetermined material.

### DESCRIPTION OF THE PREFERRED EMBODIMENTS

In the present invention, attention is focused on the fact that glass substrates for magnetic disks have different surface reflectances depending on glass types or components included in the substrates. In an apparatus for inspecting defects on the surface of a glass substrate, the light quantity level of specularly reflected light or scattered light from a substrate is examined when an illumination light beam is applied to the substrate, and it is determined whether the substrate is a predetermined substrate or whether the type of the substrate is which type at the same time when defects on the substrate are inspected.

In the following, embodiments of the present invention will be described with reference to the drawings.

### First Embodiment

First, a disk surface defect inspection apparatus will be described, in which the light quantity level of specularly reflected light or scattered light from a substrate is examined when an illumination light beam is applied to the substrate and it is determined whether the substrate is a predetermined substrate at the same time when defects on the substrate are inspected.

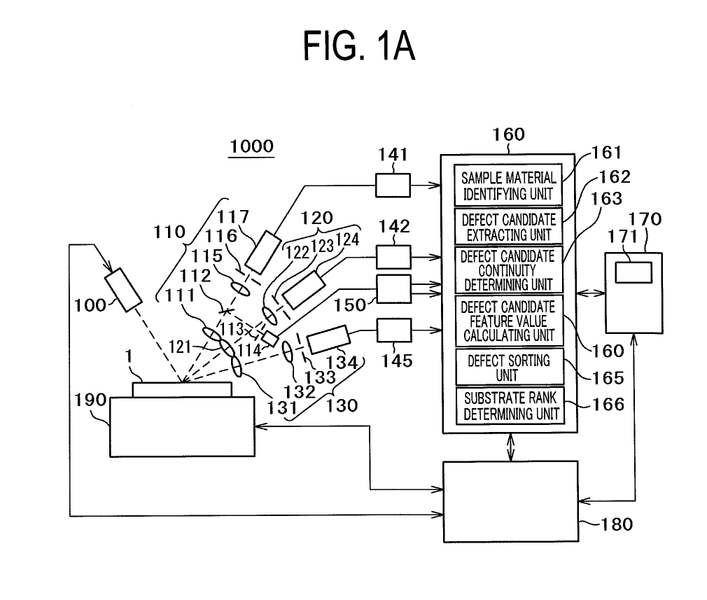

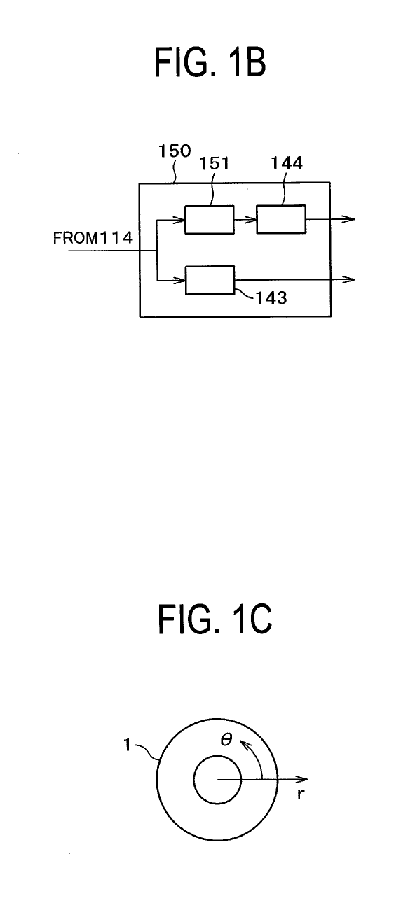

FIG. 1A is the schematic configuration of a disk surface defect inspection apparatus 1000 according to an embodiment. A sample 1, which is an inspection subject, is a magnetic disk substrate made of a glass material, in the state in which the surface is not coated with any thin films or the like and the glass material is exposed. The disk surface defect inspection apparatus 1000 includes an illuminating unit 100 that applies an illumination light beam to the sample 1, a high angle detection optical system 110 that collects and detects light reflected and scattered in a high angle direction from the sample 1 to which the illumination light beam is applied, a middle angle detection optical system 120 that collects and detects light scattered from the sample 1 in a middle angle direction, a low angle detection optical system 130 that collects and detects light scattered from the sample 1 in a low angle direction, a processing device 160 that processes signals detected at the angle detection optical systems, an input/output unit 170 that inputs the processing conditions of the processing device 160 and outputs processed results, an overall control unit 180 that controls the overall apparatus, and a stage unit 190 that places the sample 1 thereon and moves the sample 1 in one direction while rotating the sample 1.

The illuminating unit 100 includes a laser light source that outputs a laser beam at a desired wavelength.

The high angle detection optical system 110 is an optical system that detects light reflected and scattered from the surface of the sample 1 by the illumination of light beam from the illuminating unit 100. The reflected light and scattered light detected by the high angle detection optical system 110 includes specularly reflected light traveling in the high angle direction in directions indicated by dotted lines. The high angle detection optical system 110 includes an objective lens 111 that collects light reflected and scattered from the surface of the sample 1 including specularly reflected light traveling in the high angle direction, a mirror 112 that reflects the specularly reflected light from the sample 1 which is included in the light collected by the objective lens 111, a pinhole plate 113 that blocks stray light other than the specularly reflected light while passing the specularly reflected light from the sample 1 and reflected from the mirror 112 through a pinhole of the pinhole plate 113, a specularly reflected light detector 114 that detects the specularly reflected light which has passed through the pinhole of the pinhole plate 113, a converging lens 115 that converges light collected by the objective lens 111 (scattered light from the sample 1) and not reflected by the mirror 112, a pinhole plate 116 that is located at the convergence point of the converging lens 115 and blocks unconverted light while passing the converged light through a pinhole of the pinhole plate 116, and a high angle detector 117 that detects the light passed through the pinhole of the pinhole plate 116.

The middle angle detection optical system 120 includes an objective lens 121 that collects scattered light traveling in the middle angle direction caused by the illumination of the light beam from the illuminating unit 100 and reflected and scattered from the surface of the sample 1, a converging lens 122 that converges the light collected by the objective lens 121, a pinhole plate 123 that is located at the convergence point of the converging lens 122 and blocks unconverged light while passing the converged light through a pinhole provided on the pinhole plate 123, and a middle angle detector 124 that detects the light passed through the pinhole of the pinhole plate 123.

The low angle detection optical system 130 includes an objective lens 131 that collects scattered light traveling in the low angle direction caused by the illumination of light beam from the illuminating unit 100 and reflected and scattered from the surface of the sample 1, a converging lens 132 that converges the light collected at the objective lens 131, a pinhole plate 133 that is located at the convergence point of the converging lens 132 and blocks unconverged light while passing the converged light through a pinhole provided on the pinhole plate 133, and a low angle detector 134 that detects the light passed through the pinhole of the pinhole plate 133.

Signals outputted from the detectors 117, 124, and 134 are amplified at A/D converters 141, 142, and 145, respectively, subjected to A/D conversion, and inputted to the processing device 160.

On the other hand, a signal obtained by detecting the specularly reflected light from the sample 1 at the specularly reflected light detector 114 is inputted to a pre-processing unit 150. As illustrated in FIG. 1B, the pre-processing unit 150 includes a smoothing circuit unit 151 and two A/D converters 143 and 144. The signal outputted from the specularly reflected light detector 114 and inputted to the pre-processing unit 150 is branched. One of the branched signals is amplified at the A/D converter 143 for A/D conversion, and inputted to the processing device 160. The other of the branched signals is inputted to the smoothing circuit unit 151 for smoothing, amplified at the A/D converter 144 for A/D conversion, and inputted to the processing device 160.

The processing device 160 includes a sample material identifying unit 161 that receives the signal outputted from the A/D converter 144 in the signals outputted from the pre-processing unit 150 and identifies the material of the sample 1, a defect candidate extracting unit 162 that receives the signals outputted from the detectors 114, 117, 124, and 134 and A/D converted at the A/D converters 141, 142, 143, and 145 and detects defect candidates, a defect candidate continuity determining unit 163 that receives the signal from the defect candidate extracting unit 162 and the positional information of the sample 1 from the stage unit 190 (information about a rotation angle θ and a radial direction r illustrated in FIG. 1C) and determines the connection and continuity of the detected defect candidates, a defect candidate feature value calculating unit 164 that calculates feature values (the length, width, and area in the r direction and/or in the θ direction) of a defect candidate whose connection and continuity are determined, a defect sorting unit 165 that receives signals from the defect candidate feature value calculating unit 164 and sorts defects, and a substrate rank determining unit 166 that receives the density of the sorted defects and the determined result at the sample material identifying unit 161 and ranks substrates.

The processing device 160 is connected to the input/output unit 170 that includes a display screen 171 to input inspection conditions and output inspected results. Moreover, the processing device 160 and the input/output unit 170 are connected to the overall control unit 180. The overall control unit 180 controls the illuminating unit 100, the processing device 160, the input/output unit 170, and the stage unit 190 including a stage, on which the sample 1 is placed and rotated, and the stage is movable at least in one direction of one axis in the plane in which the sample 1 is rotated.

With the configuration as above, the overall control unit 180 controls the stage unit 190 to be rotated in the state in which the sample 1 is placed on the stage unit 190, and starts moving the stage unit 190 in one direction perpendicular to the axis of rotation (in the radial direction of the sample 1) at a constant velocity.

In this state, a laser beam is applied from the illuminating unit 100 to the surface of the sample 1 rotating on the stage unit 190. The specularly reflected light among the light reflected and scattered from the surface of the sample 1 and traveling in the direction of the high angle detection optical system 110 is detected by the specularly reflected light detector 114, and the scattered light around the specularly reflected light is detected by the high angle detector 117. Among the scattered light from the surface of the sample 1 and traveling in the direction of the middle angle detection optical system 120 is detected by the middle angle detector 124, and the scattered light traveling in the direction of the low angle detection optical system 130 is detected by the low angle detector 134.

Such inspection is performed from the outer circumferential portion to the inner portion of the sample 1 while moving the sample 1 straight and rotating direction, so that the entire surface of the front side of the sample 1 can be inspected. Moreover, a substrate inverting mechanism, not illustrated, is used to turn the sample 1 upside down, and an uninspected back side surface is put upward for inspection similar to the front side surface, so that the both surfaces of the sample can be inspected.

It is noted that in the above embodiment, the pinhole plates 113, 116, 123, and 133 to block stray light are used in the high angle detection optical system 110, the middle angle detection optical system 120, and the low angle detection optical system 130, respectively. However, in the case where a polarizer is inserted in the midway point of the optical path of a laser beam emitted from the illuminating unit 100 to apply a polarized light beam to the sample 1, polarization filters may be used instead of the pinhole plates 113, 116, 123, and 133. Moreover, in the case where a single wavelength laser beam is used for a laser beam emitted from the illuminating unit 100, wavelength selecting filters may be used instead of the pinhole plates 113, 116, 123, and 133. Furthermore, such a configuration may be possible in which light of a specific polarization component at a specific wavelength is transmitted in the combined use of a polarization filter and a wavelength selecting filter.

In the case where the inspection apparatus illustrated in FIG. 1A is used to detect defects on the sample 1, the sample 1 is continuously moved in one direction (in the X-direction) while rotating the sample 1 with the stage unit 190. A laser beam is emitted from the illuminating unit 100 in this state, and applied to the surface of the sample 1.

Reflected light and scattered light generated from the sample 1 to which the laser beam is applied are detected at the high angle detection optical system 110, the middle angle detection optical system 120, and the low angle detection optical system 130.

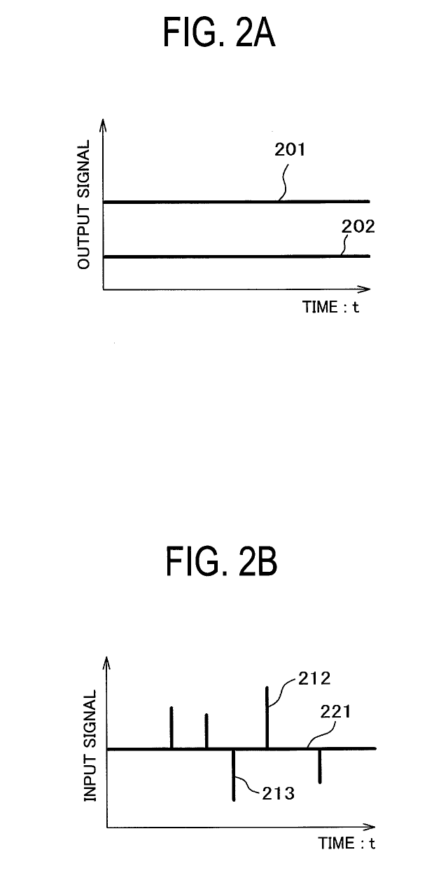

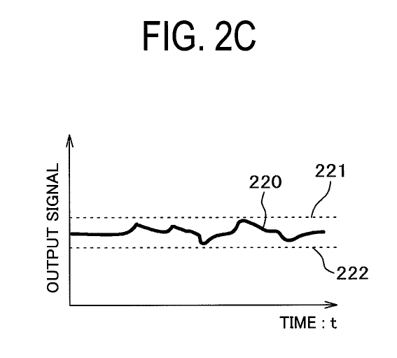

Here, in the case where the sample 1, which is an inspection subject, is a glass substrate, the reflectance of the specularly reflected light or the scattered light from the substrate surface varies when glass materials are different. Thus, even though a laser beam of the same light quantity is applied from the illuminating unit 100 to the sample 1, in case the material of the sample 1 is different, the light quantity of the specularly reflected light from the sample 1 entering the specularly reflected light detector 114, for example, is varied. In this case, the signal level outputted from the specularly reflected light detector 114 is as illustrated in FIG. 2A. Namely, the signal level outputted from the specularly reflected light detector 114 is changed depending on the material of the sample. For example, light reflected from the sample 1 of a certain material is detected at the specularly reflected light detector 114, a signal level 201 outputted from the specularly reflected light detector 114 is at high level, whereas light reflected from the sample 1 of a different material is detected at the specularly reflected light detector 114, a signal level 202 outputted from the specularly reflected light detector 114 is at low level.

In the present invention, attention is focused on differences in the light quantity of reflected light depending on sample materials. And it can be determined whether a sample, which is an inspection subject, is a substrate of a predetermined material based on differences in the levels of signals obtained by the detection of the reflected light. The sample material can be determined at the same time when detecting defects on the sample by detecting reflected light and scattered light from the sample.

In the following embodiments, an example is shown in which a sample material is determined based on the signal level outputted from the specularly reflected light detector 114. However, the present invention is not limited to the example. Such a configuration may be possible in which signal levels from the other detectors, that is, the signal level of the detector detecting scattered light in any one of the high angle, middle angle, and low angle directions or the combination of signal levels is examined to determine a sample material.

In the actual sample 1, defects exist on the surface or the inside of the sample 1 in many cases. In the case where specularly reflected light from defects on the surface or the inside of the sample 1 is detected at the specularly reflected light detector 114, the signal output is not constant like outputs illustrated in FIG. 2A. Generally, signals are affected by reflected light from defects as illustrated in FIG. 2B.

As described above, in the case where it is desired to determine the material of the sample 1 from the signal level of the detected signal of the specularly reflected light including defect signals, such a method can be considered in which the defect signals included in the detected signal of the specularly reflected light are leveled and smoothed for reducing fluctuations in the detected signal level of the specularly reflected light.

The smoothing circuit unit 151 of the pre-processing unit 150 illustrated in FIG. 1B is configured based on the concept, in which output signals from the specularly reflected light detector 114 detecting the specularly reflected light from the sample 1 are smoothed and outputted.

Namely, such the case is considered where the specularly reflected light detector 114 detects specularly reflected light from the sample 1 and inputs a signal illustrated in FIG. 2B to the pre-processing unit 150, that is, a signal at a signal level 211 when the specularly reflected light detector 114 receives specularly reflected light from portions on the sample 1 where no defects exist, a signal in a high peak waveform 212 when the specularly reflected light detector 114 receives light at relatively high level from defects on the sample 1, or a signal including a peak waveform 213 on the lower side of the signal level when the specularly reflected light detector 114 does not receive light because of defects on the sample 1. At this time, when the signal inputted to the pre-processing unit 150 is branched and inputted to the smoothing circuit unit 151, the smoothing circuit unit 151 smoothes the signal at this peak level, so that a signal 220 whose peak level is reduced and smoothed is outputted as illustrated in FIG. 2C.

The signal 220 smoothed at the smoothing circuit unit 151 is converted into a digital signal at the A/D converter 144, and inputted to the processing device 160.

On the other hand, the signal inputted to and branched at the pre-processing unit 150 and then inputted to the A/D converter 143 is amplified and converted into a digital signal similar to the signals outputted from the detectors 117, 124, and 134 and inputted to the A/D converters 141, 142, and 145, and inputted to the processing device 160.

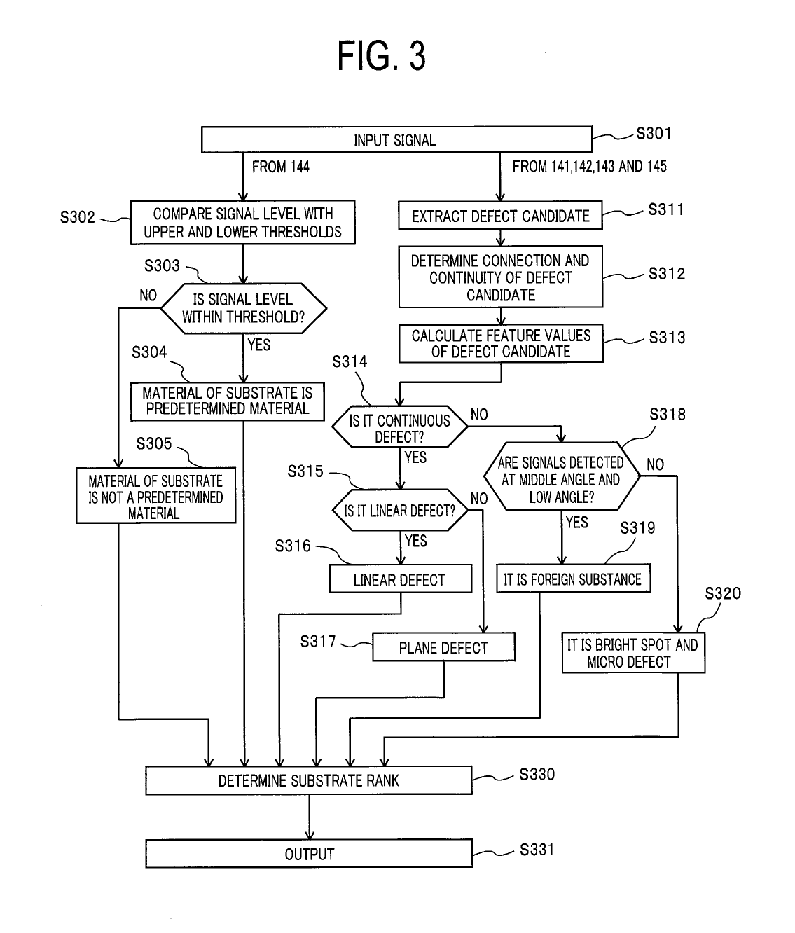

Next, the procedures of processing the signals inputted to the processing device 160 will be described with reference to FIG. 3.

The signals outputted from the A/D converters 141 to 145 are inputted to the processing device 160 (S301). Among the signals inputted from the A/D converters, the signal inputted from the A/D converter 144 is compared with an upper limit threshold 221 and a lower limit threshold 222 preset at the sample material identifying unit 161 (S302), and it is examined whether the signal falls in a range between the upper limit threshold 221 and the lower limit threshold 222, or the signal is out of the range between the upper limit threshold 221 and the lower limit threshold 222 (S303). In the case where the signal falls in the range between the upper limit threshold 221 and the lower limit threshold 222, it is determined that the sample 1, which is an inspection subject, is a sample of a predetermined material (S304), whereas in the case where the signal is out of the range between the upper limit threshold 221 and the lower limit threshold 222, it is determined that the sample 1, which is an inspection subject, is not a sample of a predetermined material (S305).

The process of examining the material of the sample 1 based on the signal inputted from the A/D converter 144 is not necessarily performed on the entire surface of the sample 1, and the process may be performed on signals detected at the specularly reflected light detector 114 for a few turns of the sample 1 at an arbitrary location on the sample 1.

On the other hand, the following process flow of detecting and sorting defects in steps from S311 to S320 is performed in parallel with processing the signal inputted from the A/D converter 144 in the steps from S302 to S305.

In the process flow of sorting defects, first, the levels of the signals inputted from the A/D converters 141 to 145 are compared with the preset threshold at the defect candidate extracting unit 162, and a signal having a level exceeding the threshold is extracted as a defect candidate in association with the positional information of the defect candidate on the sample 1 obtained from the detection system of the stage unit 190, not illustrated, (the rotation angle information of the stage 190 and the positional information about the substrate in the radial direction) (S311).

Subsequently, the positional information of the defect candidate on the sample 1 extracted at the defect candidate extracting unit 162 is used to determine the connection and continuity of the defect candidates at the defect candidate continuity determining unit 163 (S312). Defect candidates determined to have connection and continuity are subjected to the following processing as one defect.

Defect candidates, whose connection and continuity are checked, are processed to calculate feature values such as defect dimensions (the length in the r direction, the length in the θ direction, and the defect width), and the area at the defect candidate feature value calculating unit 164 (S313). At this time, defect candidates determined to have a connection and continuity at the defect candidate continuity determining unit 163 are treated as one defect and a feature value of the one defect is calculated.

Lastly, it is examined whether the defect whose feature values are calculated is a continuous defect at the defect sorting unit 165 (S314). In the case where the defect is determined as a continuous defect, it is examined whether the defect is a linear defect (S315). In the case where the continuous defect does not spread in the plane, the defect is determined as a linear defect (S316). In the case where it is determined that the continuous defect spreads in the plane, the defect is determined as a plane defect (S317).

On the other hand, in the case where it is determined that the defect is not a continuous defect in S314, it is examined whether the defect is also detected at the middle angle detector 124 and the low angle detector 134 (S318). In the case where the defect is also detected at the middle angle detector 124 and the low angle detector 134, the defect is determined as a foreign substance defect (S319). In the case where the defect is not detected at the middle angle detector 124 and the low angle detector 134, the defect is determined as a bright spot (a micro defect) (S320).

Information about defects sorted as described above and information about the result of determining the material of the substrate are sent to the substrate rank determining unit 166 for determining the rank of the substrate. Namely, in the case where it is determined that the sample 1 inspected in S304 is a substrate of a predetermined material, the rank of the sample is sorted according to the preset criteria in accordance with the type and density of the detected defect (S330), and the result is outputted to the input/output unit 170 (S331). On the other hand, in the case where it is determined that the sample 1 inspected in S305 is not a substrate of a predetermined material, information indicating that the inspected sample 1 is not a substrate of an inspection subject type material (information NG indicating that the material is not a predetermined material) is outputted to the input/output unit 170 (S331).

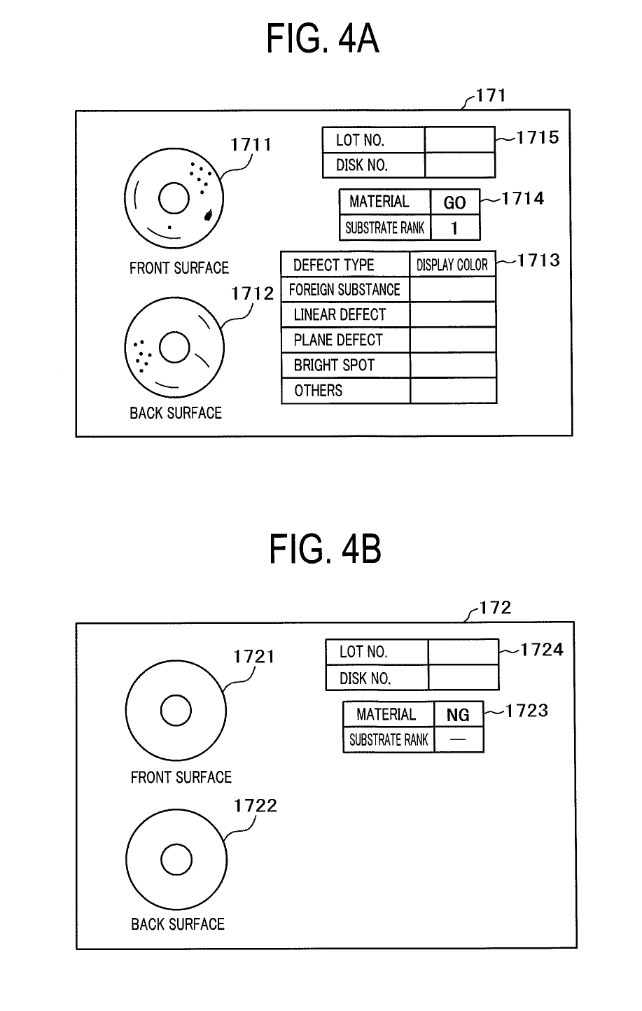

As illustrated in FIG. 4A, the input/output unit 170 receives the result determined at the substrate rank determining unit 166, displays a defect distribution 1711 on the front surface of the sample 1 and a defect distribution 1712 on the back surface on the display screen 171 in maps, and displays a defect type 1713 and a substrate ranking result 1714 together with a substrate lot number and substrate number 1715.

The defect maps may be displayed on the display screen 171 in such a way that the defect distribution 1711 on the front surface of the sample 1 and the defect distribution 1712 on the back surface are switched to display alternatively.

On the other hand, as illustrated in FIG. 4B, for the sample determined that the sample is not a sample of a predetermined material in S305 of the flow chart in FIG. 3, the defect distributions are not displayed on a defect distribution map 1721 on the front surface of the sample 1 and a defect distribution map 1722 on the back surface on the display screen 172, and information indicating that the substrate material is not a predetermined material is displayed on a substrate material display column 1723 (in the case of FIG. 4B, “NG” is displayed), together with a substrate lot number and substrate number 1724.

According to the embodiment, it is possible to automatically determine based on the level of a defect signal obtained from a signal detecting reflected light from the surface of a substrate whether the material of an inspection subject substrate is the proper material of a glass substrate at the same time when inspecting a defect, and it is possible to prevent a glass substrate of a different type material from being included in the production line of magnetic disks.

### Second Embodiment

Next, a disk surface defect inspection apparatus will be described in which the light quantity level of specularly reflected light or scattered light from a substrate is examined when an illumination light beam is applied to the substrate and distinguishing the substrate type at the same time when defects on the substrate are inspected.

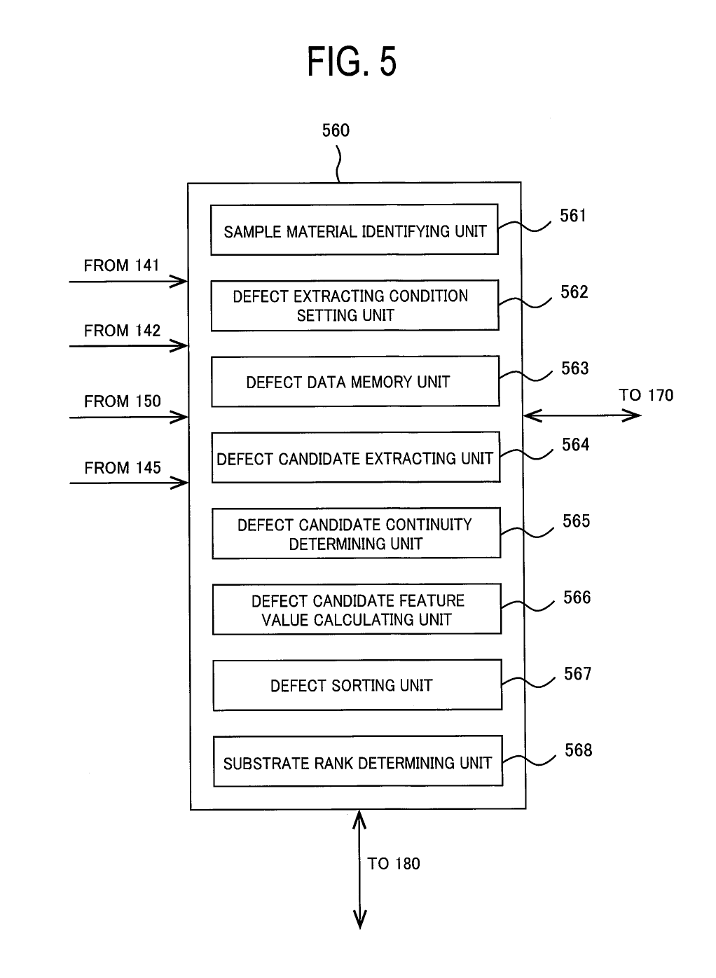

The configuration of the disk surface defect inspection apparatus according to the second embodiment is the same as the configuration of the disk surface defect inspection apparatus 1000 according to the first embodiment described in FIG. 1, except that the processing device 160 is replaced by a processing device 560 in FIG. 5, and the description of the device configuration and the motion of the individual components are omitted.

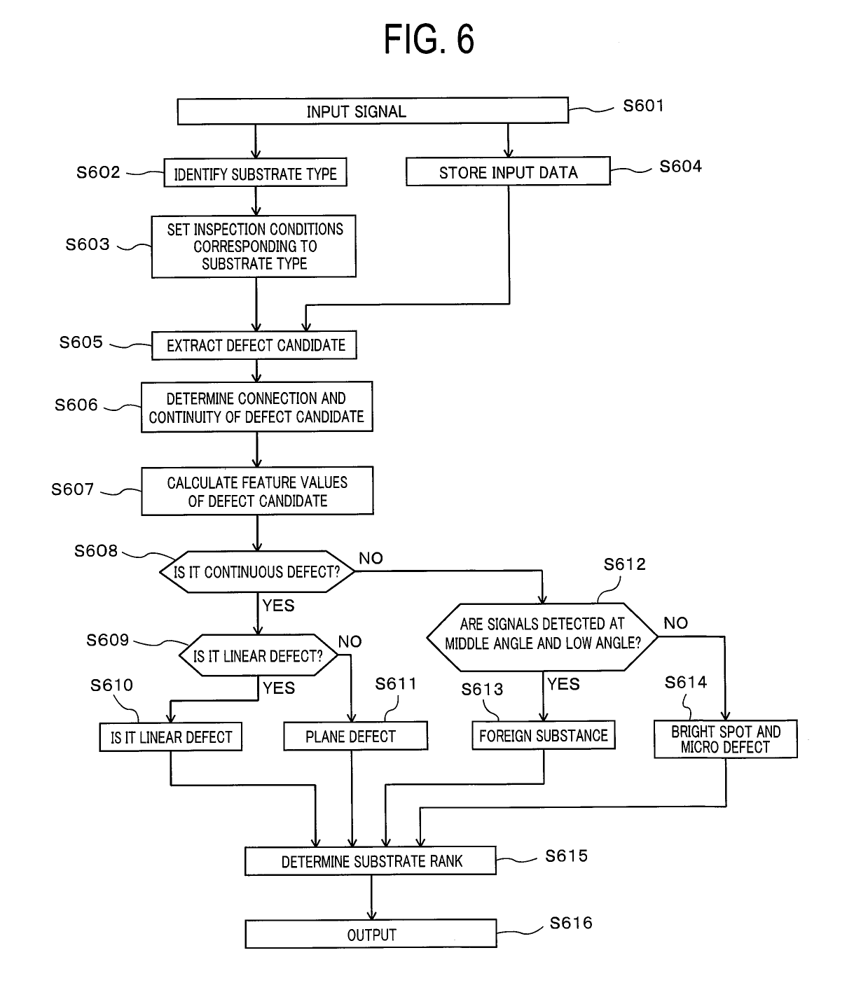

In the embodiment, the signal smoothed at the smoothing circuit unit 151 of the pre-processing unit 150 illustrated in FIG. 1B, that is, the signal 220 illustrated in FIG. 2C, for example, is digitized at the A/D converter 114, and inputted to a sample material identifying unit 561 of the processing device 560. In the processing device 560 according to the embodiment, the signal inputted from the pre-processing unit 150 is processed along the flow illustrated in FIG. 6, defect types are identified, and detected signals inputted from the detectors are processed using thresholds according to the identified defect types, so that defects are detected and sorted.

In the following, a process flow according to the embodiment will be described with reference to FIG. 6.

Signals outputted from the A/D converters 141 to 145 are inputted to the processing device 560 (S601). Among the signals detected at the detectors, the signal inputted from the A/D converter 144 of the pre-processing unit 150 is compared with the combinations of the upper limit thresholds and the lower limit thresholds according to sample materials stored in advance at the sample material identifying unit 561, and the material of the sample 1 is identified (S602).

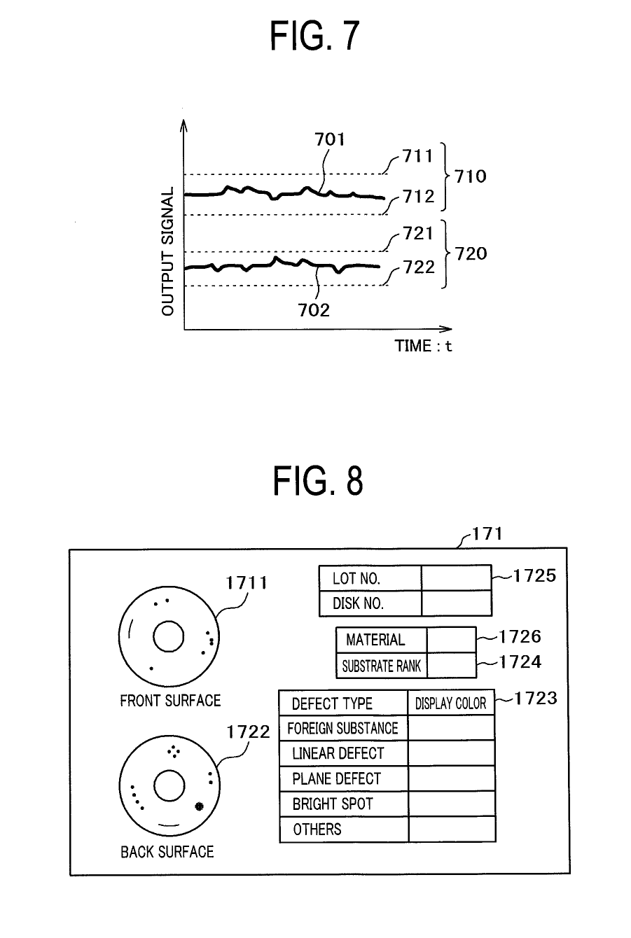

For example, in the case where the signal after smoothed and inputted from the A/D converter 144 is a signal 701 at the level as illustrated in FIG. 7, it is determined that a material corresponding to a threshold set 710 of an upper limit threshold 711 and a lower limit threshold 712 sandwiching the signal 701 is a substrate material that is a present inspection subject. On the other hand, in the case where a signal inputted from the A/D converter 144 is a signal 702 at the level as illustrated in FIG. 7, it is determined that a material corresponding to a threshold set 720 of an upper limit threshold 721 and a lower limit threshold 722 sandwiching the signal 702 is a substrate material that is a present inspection subject.

The process of determining the material of the sample 1 based on the signal inputted from the A/D converter 144 is not necessarily performed on the entire surface of the sample 1. Detected signals from the specularly reflected light detector 114 may be processed for a few turns from the location to start inspecting the sample 1.

Subsequently, the inspection conditions according to the substrate material determined at the sample material identifying unit 561 are extracted from data of the inspection conditions stored in advance in association with substrate materials at a defect extracting condition setting unit 562, and the inspection conditions are set to a defect candidate extracting unit 564 (S603).

On the other hand, while performing the steps from S601 to S603 on the signals detected at the specularly reflected light detector 114 for a few turns from the location to start inspecting the sample 1, the signals inputted from the A/D converters 141, 142, 143, and 145 are stored in a defect data memory unit 563 (S604).

Subsequently, in the state in which the inspection conditions are set to the defect candidate extracting unit 564 in S603, the signals inputted from the A/D converters 141, 142, 143, and 145 and stored in the defect data memory unit 563 are read out in turn to perform the process of extracting defect candidates at the defect candidate extracting unit 564 (S605).

The process of extracting defect candidates is the same as the process in Step S311 described in the first embodiment, in which the signal levels inputted from the A/D converters 141 to 145 are compared with thresholds set as the inspection conditions in the defect candidate extracting unit 564, the signal at the level exceeding the threshold is a defect candidate, and the defect candidate is extracted in association with the positional information of the defect candidate on the sample 1 (the rotation angle information of the stage 190 and positional information about the substrate in the radial direction) obtained from the detection system of the stage unit 190, not illustrated.

Subsequently, the positional information of the defect candidate on the sample 1 extracted at the defect candidate extracting unit 564 is used to determine the connection and continuity of the defect candidates at a defect candidate continuity determining unit 565 (S606). Defect candidates determined to have connection and continuity are subjected to the following processing as one defect.

Defect candidates, whose connection and continuity are checked, are processed to calculate feature values such as defect dimensions (the length in the r direction, the length in the θ direction, and the defect width), and the area at a defect candidate feature value calculating unit 566 (S607). At this time, defect candidates determined to have a connection and continuity at the defect candidate continuity determining unit 565 are treated as one defect and a feature value of the one defect is calculated.

Lastly, it is examined whether the defect whose feature values are calculated is a continuous defect at a defect sorting unit 567 (S608). In the case where the defect is determined as a continuous defect, it is examined whether the defect is a linear defect (S609). In the case where the continuous defect does not spread in the plane, the defect is determined as a linear defect (S610). In the case where it is determined that the continuous defect spreads in the plane, the defect is determined as a plane defect (S611).

On the other hand, in the case where it is determined that the defect is not a continuous defect in S608, it is examined whether the defect is also detected at the middle angle detector 124 and the low angle detector 134 (S612). In the case where the defect is also detected at the middle angle detector 124 and the low angle detector 134, the defect is determined as a foreign substance defect (S613). In the case where the defect is not detected at the middle angle detector 124 and the low angle detector 134, the defect is determined as a bright spot (a micro defect) (S614).

Information about defects sorted as described above and information about the result of determining the material of the substrate are sent to a substrate rank determining unit 568, and the rank of the substrate is determined. Namely, the rank of the sample is sorted according to the preset criteria in accordance with the type and density of the detected defect (S615), and the result is outputted to the input/output unit 170 (S616).

As illustrated in FIG. 8A, the input/output unit 170 receives the result determined at the substrate rank determining unit 568, displays the defect distribution 1721 on the front surface of the sample 1 and the defect distribution 1722 on the back surface on the display screen 171 in maps, and displays the defect type 1723 and the substrate ranking result 1724 together with a substrate lot number and substrate number 1725. Moreover, the input/output unit 170 displays information 1726 about the substrate type identified in S602.

The defect maps may be displayed on the display screen 171 in such a way that one of the defect distribution 1721 on the front surface of the sample 1 or the defect distribution 1722 on the back surface is displayed.

According to the embodiment, it is possible to determine the material of an inspection subject substrate based on the level of a defect signal obtained from a signal detecting reflected light and scattered light from the surface of a substrate made of a glass material according to the glass material, and it is possible to perform inspection using the inspection conditions according to the identified material. Accordingly, it is possible to accurately perform inspection, even though a glass substrate of a different type material is included in the production line of magnetic disks.

As described above, the invention invented by the present inventors is described specifically based on the embodiments. It is without saying that the present invention is not limited to the embodiments, and the present invention can be modified and altered variously within the scope not departing from the teachings.

The present invention may be embodied in other specific forms without departing from the spirit or essential characteristics thereof. The present embodiment is therefore to be considered in all respects as illustrative and not restrictive, the scope of the present invention being indicated by the appended claims, rather than by the foregoing description, and all changes which come within the meaning and range of equivalency of the claims are therefore intended to be embraced therein.

1. A disk surface inspection apparatus comprising:
a stage unit on which a disk that is a sample is placed, the stage unit being rotatable and movable in a direction perpendicular to a center axis of rotation;
an illuminating unit configured to apply a light beam to the sample placed on the stage unit;
a first detecting unit configured to detect light reflected and scattered from the sample in a first direction by the illumination of light beam from the illuminating unit;
a second detecting unit configured to detect light reflected and scattered from the sample in a second direction by the illumination of light beam from the illuminating unit applying the light beam to the sample; and
a processing unit configured to process a first detection signal obtained by detecting the light reflected and scattered from the sample in the first direction at the first detecting unit and a second detection signal obtained by detecting the light reflected and scattered from the sample in the second direction at the second detecting unit and detect a defect on the sample,
wherein the processing unit compares a preset threshold with an output level of the first detection signal detecting the light reflected and scattered from the sample in the first direction at the first detecting unit or an output level of the second detection signal detecting light reflected and scattered from the sample in the second direction at the second detecting unit, and determines whether a material of the disk that is the sample is a predetermined material.

2. The disk surface inspection apparatus according to claim 1, further comprising a smoothing unit configured to smooth the first detection signal detected by the first detecting unit or the second detection signal detected by the second detecting unit,
wherein the processing unit compares the preset threshold with a level of a signal that the first detection signal is smoothed at the smoothing unit, or a level of a signal that the second detection signal is smoothed at the smoothing unit, and determines whether a material of the disk that is the sample is a predetermined material.

3. The disk surface inspection apparatus according to claim 1,
wherein the processing unit compares the preset threshold with a level of a signal that specularly reflected light is extracted and the first detection signal detected at the first detecting unit is smoothed in the light reflected and scattered from the sample in the first direction, and determines whether a material of the disk that is the sample is a predetermined material.

4. The disk surface inspection apparatus according to claim 1, further comprising a display unit configured to display a result processed at the processing unit on a screen,
wherein the display unit displays a number to identify the sample and a result of determining whether a material of the disk that is the sample is a predetermined material on the screen of the display unit.

5. The disk surface inspection apparatus according to claim 1,
wherein the disk that is the sample is formed of glass.

6. A disk surface inspection method, comprising the steps of:
rotating a disk that is a sample and applying a light beam to the sample while moving the sample in a direction perpendicular to a center axis of rotation;
detecting light reflected and scattered from the sample, on which the light is applied, in a first direction to obtain a first detection signal;
detecting light reflected and scattered from the sample, on which the light is applied, in a second direction to obtain a second detection signal;
processing the first detection signal and the second detection signal to detect a defect on the sample; and
comparing a preset threshold with an output level of the first detection signal or an output level of the second detection signal to determine whether a material of the disk that is the sample is a predetermined material.

7. The disk surface inspection method according to claim 6,
wherein comparing the preset threshold with the output level of the first detection signal or the output level of the second detection signal is comparing the preset threshold with a level of a signal that the first detection signal is smoothed or a level of a signal that the second detection signal is smoothed to determine whether a material of the disk that is the sample is a predetermined material.

8. The disk surface inspection method according to claim 6,
wherein the preset threshold is compared with a level of a signal that specularly reflected light is extracted to detect the first detection signal and the first detection signal is smoothed in light reflected and scattered from the sample in the first direction, and it is determined whether a material of the disk that is the sample is a predetermined material.

9. The disk surface inspection method according to claim 6,
wherein a result of detecting a defect on the sample and a result of determining whether a material of the disk is the same with is a predetermined material are displayed on a screen together with a number to identify the sample.

10. The disk surface inspection method according to claim 6,
wherein the disk that is the sample is formed of glass.
